(19) United States
(12) Patent Application Publication
(10) Pub. No.: US 2003/0236590 A1
(43) Pub. Date: Dec. 25, 2003

(54) Apparatus and method of recognizing position and direction of mobile robot

(75) Inventors: Ki-Cheol Park, Hwasung-City (KR); San-Heon Park, Suwon-City (KR); Won-Jun Ko, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/348,979

(22) Filed: Jan. 23, 2003

(30) Foreign Application Priority Data
Jun. 12, 2002 (KR) 2002-32714

(51) Int. Cl. G06F 19/00

(52) U.S. Cl. 700/245; 318/568.12

(57) ABSTRACT

An apparatus and method of recognizing a position and direction of a mobile robot includes obtaining absolute coordinates at a current position of the mobile robot and relative coordinates for a moving displacement of the mobile robot. Therefore, the position and direction of the mobile robot are recognized by reflecting the relative coordinates on the absolute coordinates. Accordingly, the present invention operates odometry and RFID coordinate systems in combination with each other, thus obtaining a high sampling rate by the odometry coordinate system while restricting an error range within a predetermined level by the RFID coordinate system.

### CROSS-REFERENCE TO RELATED APPLICATION

This application claims the benefit of Korean Application No. 2002-32714, filed Jun. 12, 2002, in the Korean Intellectual Property Office, the disclosure of which is incorporated herein by reference.

### BACKGROUND OF THE INVENTION

1. Field of the Invention

The present invention relates generally to mobile robots, and more particularly, to an apparatus and method of recognizing a position and direction of a mobile robot.

2. Description of the Related Art

Generally, robots perform various tasks normally performed by human beings, in a variety of industrial applications. For example, the robots perform tasks such as welding operations and assembly operations in production plants. A robot typically performs the welding and assembly operations with a robotic arm. The robotic arm has several joints and is fixedly installed to perform instructed tasks. A work space of the robot arm may be extremely limited.

A mobile robot, unlike the robotic arm, is not fixedly installed, but moves relatively freely. The mobile robot is used to move parts and working tools required for production of products, to desired positions. Further, the mobile robot may perform tasks such as assembling the moved parts to produce products. Recently, many cases of the use of mobile robots in home applications as well as industrial applications have been disclosed. In the home applications, the mobile robot performs tasks such as cleaning or moving objects.

In order to utilize the mobile robot in the industrial and the home applications, the mobile robot must precisely recognize its current position. That is, the mobile robot must precisely recognize its position so as to precisely produce products in the industrial applications, and to ensure safety of a user and protect the user's property in the home applications.

The most typical method of recognizing the position and direction of the mobile robot is odometry. Odometry is also called dead-reckoning. A mobile robot employing odometry obtains velocity information using an odometer and a wheel sensor. The mobile robot also employs odometry by obtaining azimuth angle information using a magnetic sensor, so that the mobile robot recognizes its position and direction by calculating information on a moving distance and direction ranging from an initial position to a current position.

FIG. 1 is a view showing a concept of a conventional position and direction recognition in an odometry coordinate system. As shown in FIG. 1, the position of a mobile robot 102 in the odometry coordinate system is determined by coordinates xᵣ and yᵣ at a position where a pivot 108 of the mobile robot 102 is located. Further, the direction of the mobile robot 102 is determined by an angle tᵣ between a front direction of the mobile robot 102 and an x-axis.

The odometry method uses only information generated in the mobile robot without input of additional information from an outside source. In the odometry method, the position information is rapidly updated because the position information is obtained at a very high sampling rate. Further, the odometry method has great precision over a relatively short distance, and is inexpensive. However, the odometry method is disadvantageous in that, since it calculates the position and direction of the mobile robot through a method of integral calculus, measurement error is accumulated in regard to a traveling distance of the mobile robot. For example, the mobile robot may slide according to conditions of a floor of a work area. Error caused by the sliding is not fully corrected, but accumulated over time, thus causing problems.

Another method of recognizing the position and direction of the mobile robot is a method using a radio frequency identification (RFID) card and an RFID reader. In this method, a plurality of RFID cards each with unique position information assigned thereto, are laid in the floor of a work area of the mobile robot. The mobile robot reads the unique position information by detecting the RFID cards through the RFID reader while moving on the floor of the work area, thus recognizing a current position of the mobile robot. The RFID card is passively detected by the RFID reader, so it does not require a supply of power.

FIG. 2 is a view showing a concept of a conventional position and direction recognition in an RFID coordinate system. As shown in FIG. 2, the current position of a mobile robot (not shown) is detected by coordinates x_{c} and y_{c} of an RFID card 204 detected currently by the mobile robot based on a plurality of RFID cards 202 laid in the floor of the work area in a form of a lattice. The RFID cards 202 store unique numbers, respectively, and the mobile robot has RFID coordinate values corresponding to the unique numbers in the form of a reference table. The mobile robot obtains a corresponding unique number by detecting a corresponding RFID card through the RFID reader, and searches the reference table for the RFID coordinate values corresponding to the unique number, thus recognizing the current position of the mobile robot.

In the position and direction recognizing method using RFID, precision in recognition of the position and direction of the mobile robot is determined according to distribution density of RFID cards. If the distribution density of the RFID cards is excessively low, the precise recognition of the position and direction of the mobile robot cannot be expected. On the contrary, if the distribution density of the RFID cards is excessively high, error in reading of unique numbers may occur due to mutual interference between RF signals outputted from the RFID cards.

FIG. 3 is a view showing a concept of error generated due to mutual interference between RFID cards with excessively high distribution density in the conventional position and direction recognizing method using RFID. As shown in FIG. 3, if a power RF signal is outputted from an RFID reader 308, RFID cards 302 laid in a work floor 304 output data RF signals to the RFID reader 308.

In FIG. 3, the RFID reader 308 desires to recognize only an RFID card 302b and read a unique number of the RFID card 302b. However, error may occur in which the RFID reader 308 cannot exactly read only the unique number of the RFID card 302b which is a target of the RFID reader 308 due to interference of RF signals outputted from RFID cards 302a and 302c adjacent to the RFID card 302b. Therefore, in order to prevent a generation of error, the distribution density of laid RFID cards is necessarily restricted within a suitable range. However, this restriction deteriorates the precision of the position and direction recognizing method using RFID. Further, error may occur even if a magnetically active object exists in a place where the RFID cards are laid. Furthermore, the RFID method must recognize two or more RFID cards simultaneously so as to recognize a direction of the mobile robot. In this case, if the distribution density of the RFID cards is not sufficiently high, it is difficult to recognize the direction.

Error characteristics of the above-described conventional odometry method and the RFID method are depicted in FIG. 4. As shown in FIG. 4, the odometry method rapidly updates the position and direction information due to the high sampling rate of an angle sensor. However, it increases integral error as the traveling distance of the mobile robot increases. On the other hand, the RFID method has a restrictive error range since error is not accumulated. However, it relatively slowly updates new position and direction information because sampling operations of position and direction sensors are intermittently performed.

### SUMMARY OF THE INVENTION

Accordingly, it is an aspect of the present invention to provide an apparatus and method of recognizing a position and direction of a mobile robot, which stably recognize the position and direction of the mobile robot at a high sampling rate and within a restricted error range.

Additional aspects and advantages of the invention will be set forth in part in the description which follows and, in part, will be obvious from the description, or may be learned by practice of the invention.

The foregoing and other aspects of the present invention are achieved by providing a mobile robot including an absolute coordinate detecting unit to obtain absolute coordinates at a current position of the mobile robot, a relative coordinate detecting unit to obtain relative coordinates for a moving displacement of the mobile robot, and a control unit to recognize a position and direction of the mobile robot by reflecting the relative coordinates on the absolute coordinates.

### BRIEF DESCRIPTION OF THE DRAWINGS

The above and other aspects and advantages of the invention will become apparent and more appreciated from the following description of the preferred embodiments, taken in conjunction with the accompanying drawings of which:

FIG. 1 is a view showing a concept of a conventional position and direction recognition in an odometry coordinate system;

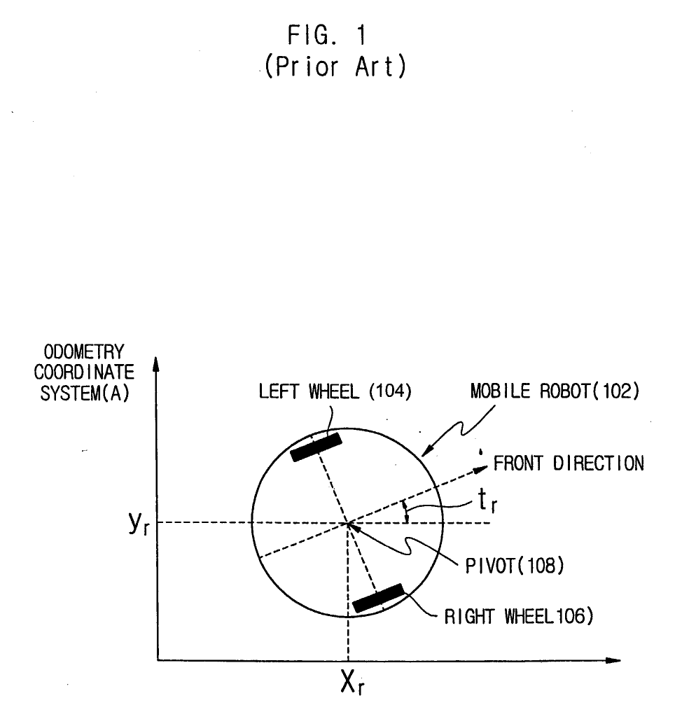

FIG. 2 is a view showing a concept of a conventional position and direction recognition in an RFID coordinate system;

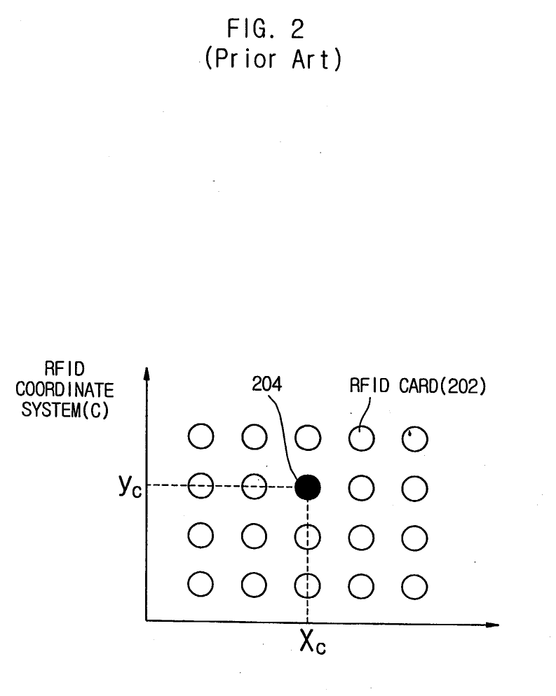

FIG. 3 is a view showing a concept of error generated due to mutual interference between RFID cards with excessively high distribution density in the conventional position and direction recognizing method using RFID;

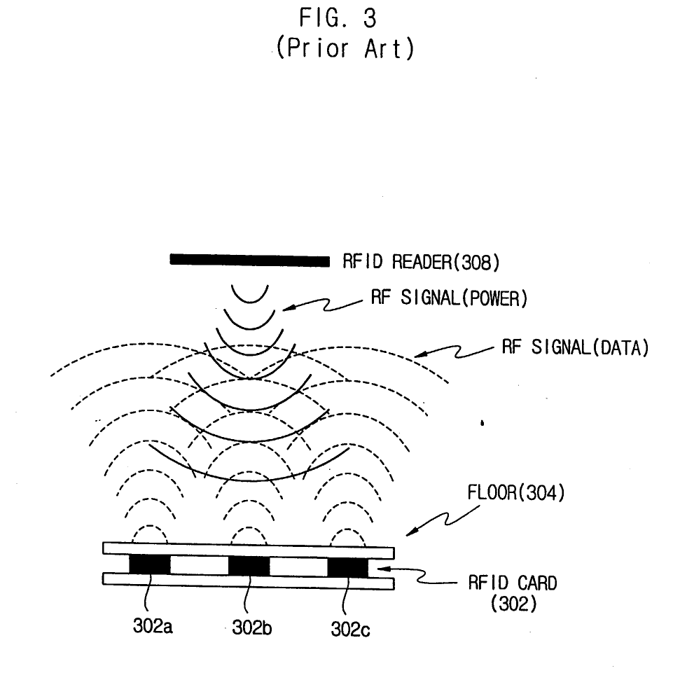

FIG. 4 is graph showing error characteristics of the conventional odometry and RFID methods;

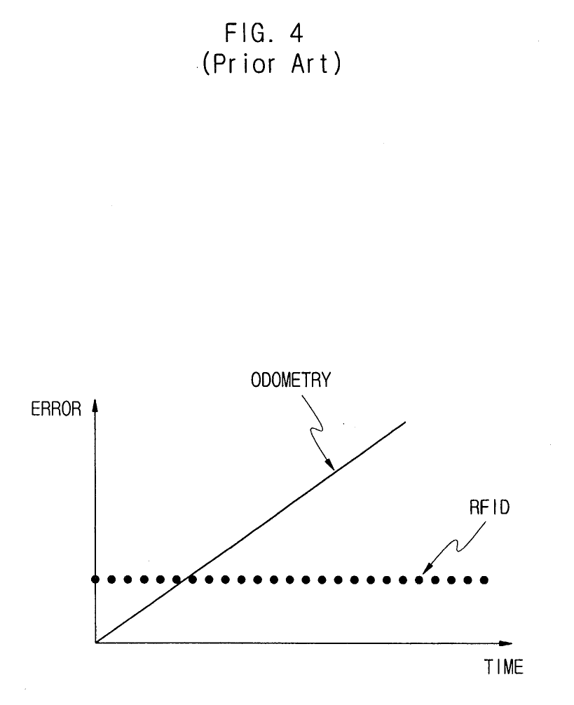

FIG. 5 is a block diagram of a control apparatus of a mobile robot, according to an embodiment of the present invention;

FIG. 6A is a block diagram showing a plurality of RFID reader modules directly connected to a control unit of the mobile robot of the present invention;

FIG. 6B is a view showing a construction in which an RFID reader system is disposed between the control unit of the mobile robot and the plurality of RFID reader modules as shown in FIG. 6A;

FIG. 7 is a view showing a shape of an RFID card of the present invention;

FIG. 8A is a view showing a state in which odometry and RFID coordinate systems of the mobile robot do not coincide with each other;

FIG. 8B is a view showing a state in which odometry and RFID coordinate systems coincide with each other in a method of recognizing a position and direction of the mobile robot of the present invention;

FIG. 9 is a view showing an odometry coordinate system obtained when an i-th RFID card is detected by a k-th RFID reader of the mobile robot in the position and direction recognition method of the mobile robot of the present invention;

FIG. 10 is a view showing a test motion to make the odometry and RFID coordinate systems of the mobile robot coincide with each other;

FIG. 11 is a view showing relations of unknown numbers required to make the odometry and RFID coordinate systems coincide in the position and direction recognition of the mobile robot of the present invention;

FIG. 12A is a flowchart of an algorithm performed by the RFID reader modules if an RFID card is not detected;

FIG. 12B is a flowchart of an algorithm performed by the RFID reader modules to reduce an amount of communication; and

FIG. 13 is a graph showing error characteristics of the method of recognizing the position and direction of the mobile robot of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

A position recognizing apparatus and method using RFID cards and an RFID reader is disclosed in Korean Patent Application No. 2002-19039.

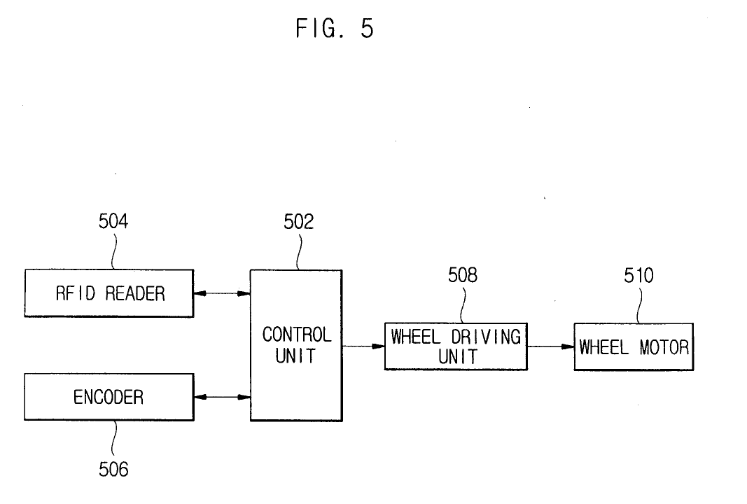

Distinct from the above-mentioned position recognizing apparatus and method using RFID cards and an RFID reader, FIG. 5 is a block diagram of a control apparatus of a mobile robot, according to an embodiment of the present invention. As shown in FIG. 5, an RFID reader 504 and an encoder 506 are connected to an input terminal of the control unit 502. The RFID reader 504 detects RFID cards, obtains unique numbers of the detected RFID cards, and transmits the unique numbers to the control unit 502. The unique numbers of the RFID cards detected by the RFID reader 504, are used to obtain RFID coordinates of the mobile robot. The encoder 506 detects a rotating speed and rotating direction of wheels of the mobile robot, and transmits corresponding detected values to the control unit 502. The rotating speed and direction of the wheels detected by the encoder 506, are used to obtain odometry coordinates of the mobile robot. The mobile robot recognizes its current position using position information obtained by the RFID reader 504 and the encoder 506, and moves to a destination by driving a wheel driving unit 508 and a wheel motor 510.

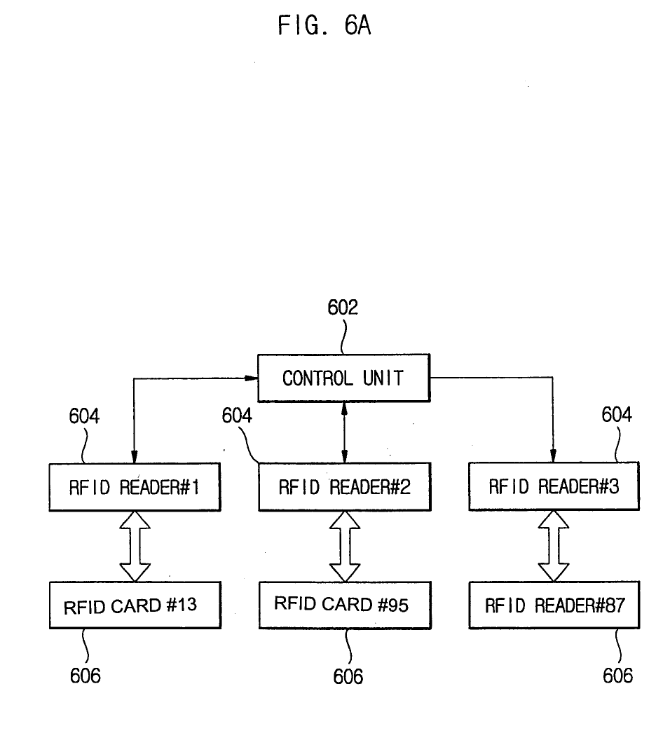

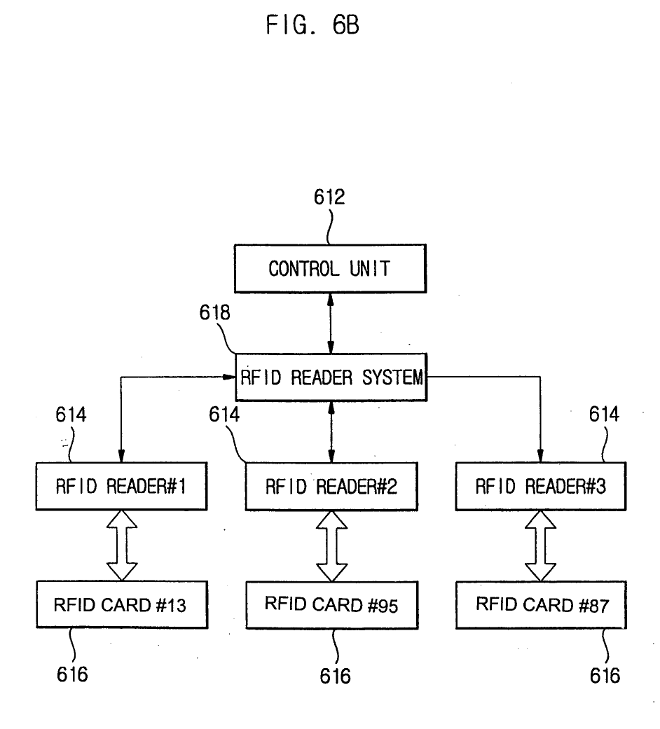

FIG. 6A is a block diagram showing a plurality of RFID reader modules directly connected to a control unit 602 of the mobile robot of the present invention. As shown in FIG. 6A, a plurality of RFID reader modules 604 obtain unique numbers by detecting RFID cards 606, and directly transmit the unique numbers to the control unit 602. The control unit 602 obtains RFID coordinates corresponding to each of the unique numbers from a reference table, thus recognizing the current position of the mobile robot in the RFID coordinate system. As described above, communication is directly performed between the control unit 602 and the RFID reader modules 604 of the mobile robot, thereby remarkably improving communication speed.

However, if the control unit 602 of the mobile robot communicates with a great number of RFID reader modules 604, a load of the control unit 602 may excessively increase. Therefore, as shown in FIG. 6B, an RFID reader system 618 is disposed between a control unit 612 and RFID reader modules 614 to allow the RFID reader modules 614, which obtain unique numbers from RFID cards 616, to communicate with the RFID reader system 618, such that a load of the control unit 612 may be reduced.

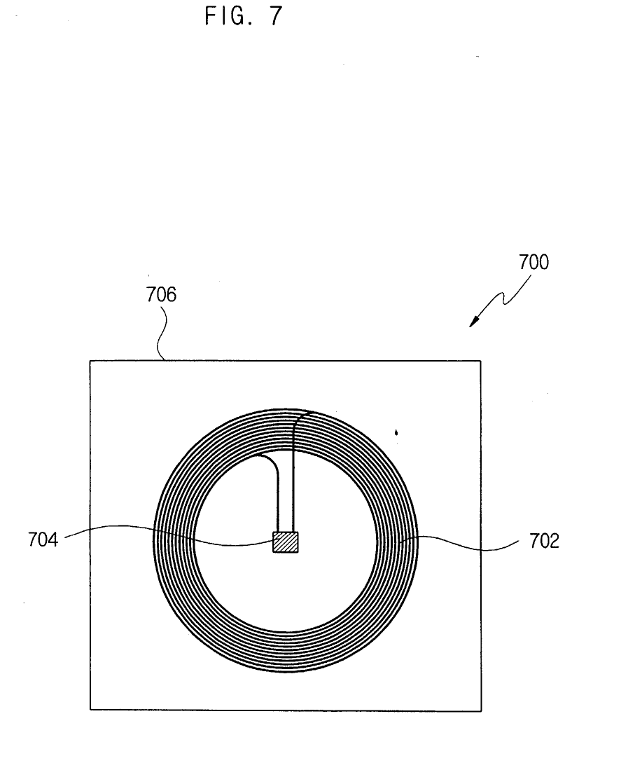

FIG. 7 is a view showing a shape of an RFID card of the present invention. As shown in FIG. 7, an RFID card 700 of the present invention is designed such that a circular coil 702 is formed between two relatively thin rectangular panels 706. Both ends of the coil 702 are extended to the inside of the coil 702, and a circuit unit 704 is connected to the both ends of the coil 702. The coil 702 is formed in a shape of a circle so as to remove detection error in a moving direction when the mobile robot of the present invention detects the RFID card 700 while moving. That is, if the coil 702 is formed in a shape of a rectangle, etc., points of time taken to detect the RFID card may be different when the mobile robot approaches the RFID card 700 in a direction of a corner of the coil and in a direction of a side of the coil, thus causing error in detecting the RFID card relative to an approaching direction of measurement. Therefore, the coil 702 is formed in the shape of a circle, thus obtaining identical detection points of time regardless of approaching directions of the mobile robot.

The circuit unit 704 of FIG. 7 includes resistors, capacitors and a microchip (not shown). Of these components, the microchip includes a rectifying device, a basic RF modulation device and a non-volatile memory. The non-volatile memory included in the microchip is used to store a unique number representing a position of the RFID card 700. In this case, electrical erasable and programmable read only memory (EEPROM), which enables reading and writing of data, may be used as the non-volatile memory. Alternatively, electrical programmable ROM (EPROM) enabling only reading of data may be used as the non-volatile memory. The EEPROM enables writing/reading of data, so that position information of the RFID card 700 is freely changed according to requirements, thus providing great flexibility to an application of the mobile robot of the present invention. On the contrary, the EPROM enables only reading of a unique number prestored therein. However, the EPROM is inexpensive relative to the EEPROM, thus reducing costs related to installation and maintenance of RFID cards.

The mobile robot of the present invention having the above-described construction has two coordinate systems because it operates the odometry and RFID methods in combination with each other. The odometry coordinate system is a relative coordinate system, in which a final position and direction of the mobile robot are determined relative to the position of the mobile robot determined when coordinate values are initialized. On the other hand, the RFID coordinate system is an absolute coordinate system, in which an absolute position of the mobile robot is recognized by detecting laid RFID cards, because positions of the RFID cards laid in a floor of a work area are fixed and unique numbers are respectively assigned to the RFID cards.

Therefore, in order to operate the odometry and RFID methods in combination with each other in the mobile robot of the present invention, the RFID coordinate system, which is an absolute coordinate system, and the odometry coordinate system, which is a relative coordinate system, must be aligned as one coordinate system. If initialization states of the odometry coordinate system do not coincide with coordinate axes of the RFID coordinate system, the odometry and RFID coordinate systems cannot operate in combination with each other. Accordingly, it is required to align coordinate axes of the odometry and RFID coordinate systems.

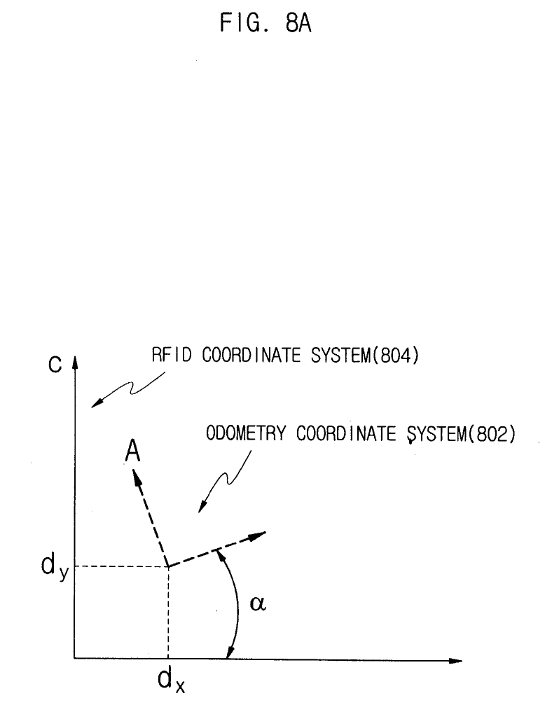

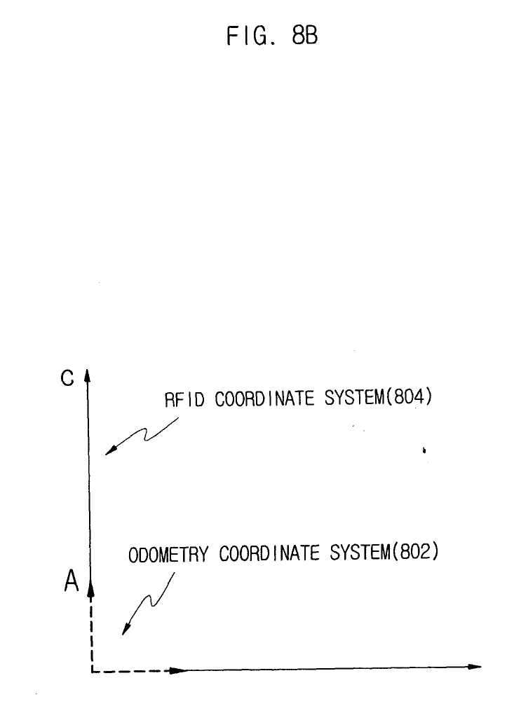

FIG. 8A is a view showing a state in which odometry and RFID coordinate systems of the mobile robot of the present invention do not coincide with each other. As shown in FIG. 8A, in the mobile robot which recognizes its position and direction by operating the odometry and RFID methods in combination with each other, an odometry coordinate system 802 does not always coincide with an RFID coordinate system 804. If the odometry coordinate system 802 and the RFID coordinate system 804 do not coincide with each other, respective advantages of the odometry and RFID methods cannot be realized. Thus, their advantages are obtained when the two coordinate systems coincide with each other.

As shown in FIG. 8A, an origin of the odometry coordinate system 802 is spaced apart from that of the RFID coordinate system 804 by dₓ in the x-direction, and by d_{y} in the y-direction. Further, the odometry coordinate system 802 is rotated at an angle of α relative to the RFID coordinate system 804. As shown in FIG. 8B, the odometry coordinate system 802 coincides with the RFID coordinate system 804 by calculating the distances dₓ and d_{y} and the angle α, moving the odometry coordinate system 802 by −dₓ in the x-direction and by −d_{y} in the y-direction, and rotating the odometry coordinate system 802 by an angle of −α.

However, since an origin of the odometry coordinate system 802 is fixed to a pivot of the mobile robot, the alignment of coordinate systems only allows the pivot and direction of the mobile robot to coincide with the RFID coordinate system. If the RFID reader is mounted at a position deviated from the pivot of the mobile robot, the position and direction of the mobile robot may be precisely recognized when the position and direction of the mobile robot are calculated taking in to account a distance and a direction between the pivot of the mobile robot and a mounting position of the RFID reader.

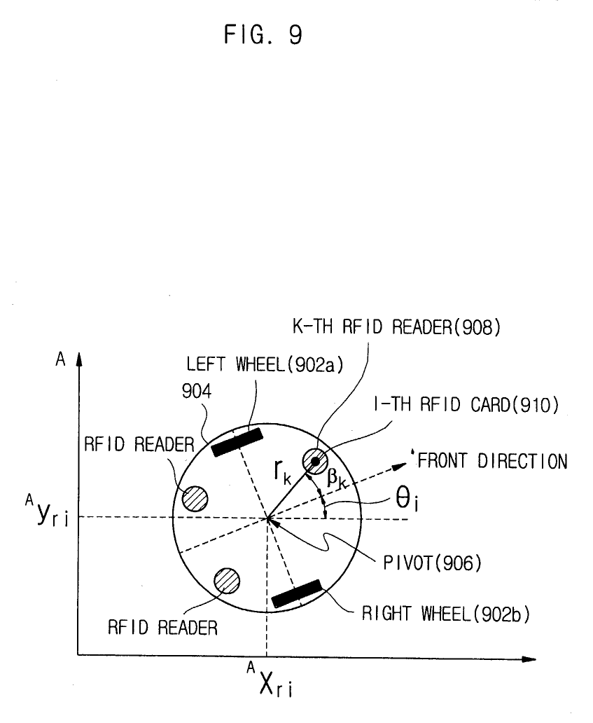

FIG. 9 is a view showing an odometry coordinate system obtained when an i-th RFID card is detected by a k-th RFID reader of the mobile robot in the position and direction recognition method of the mobile robot of the present invention. As shown in FIG. 9, a mobile robot 904 moves by a forward and reverse rotation of both a left wheel 902a and a right wheel 902b, and turns by differential rotation of the two wheels 902a and 902b. Therefore, an actual position of the mobile robot 904 is the position of a pivot 906, which is determined according to the mounting positions of the wheels 902a and 902b, and reflects the position of a k-th RFID reader 908 which detects an RFID card 910.

In FIG. 9, the pivot 906 of the mobile robot 904 is located at a position spaced apart from an origin by ^{A}xᵣᵢ in the x-direction of the odometry coordinate system, and by ^{A}yᵣᵢ in the y-direction thereof. A distance rₖ and an angle βₖ between the pivot 906 and the k-th RFID reader 908 are previously known values according to specifications of the mobile robot 904. Thus, βₖ is an angle between a front direction of the mobile robot 904 and the k-th RFID reader 908, so that an actual angle between the x-axis of the odometry coordinate system and the k-th RFID reader 908 is βₖ added to θᵢ.

Consequently, in order to make the odometry coordinate system 802 coincide with the RFID coordinate system 804, the distances dₓ and d_{y} and the angle α of FIG. 8 are obtained, the odometry coordinate values ^{A}xᵣᵢ and ^{A}yᵣᵢ of FIG. 9 are reflected on the obtained results, and the distance rₖ and the angle βₖ+θᵢ between the pivot of the mobile robot and the RFID reader are additionally reflected on the above-reflected results, thus obtaining information required to make the odometry and RFID coordinate systems coincide with each other.

Information required to make the odometry and RFID coordinate systems of the mobile robot coincide is summarized as follows. First, in the RFID coordinate system, a position vector ^{c}Pᵢ of the k-th RFID reader which detects the i-th RFID card is represented by the following Equation.

$${}_{}^{C}{P}{}_{i}^{} = [ \begin{matrix}{}_{}^{C}{x}{}_{i}^{} \\ {}_{}^{C}{y}{}_{i}^{} \\ 1\end{matrix} ] \qquad ( 1 )$$

Further, in the odometry coordinate system, a position vector ^{A}Pᵣᵢ of the pivot of the mobile robot is represented by the following Equation.

$${}_{}^{A}{P}{}_{r i}^{} = [ \begin{matrix}{}_{}^{A}{x}{}_{r i}^{} \\ {}_{}^{A}{y}{}_{r i}^{} \\ 1\end{matrix} ] \qquad ( 2 )$$

In the odometry coordinate system, a position vector ^{A}Pᵢ of the k-th RFID reader which detects the i-th RFID card is represented by the following Equation.

$${}_{}^{A}{P}{}_{ i}^{} = [ \begin{matrix}{}_{}^{A}{x}{}_{i}^{} \\ {}_{}^{A}{y}{}_{i}^{} \\ 1\end{matrix} ] \qquad ( 3 )$$

^{A}pᵢ of Equation (3) is represented again by ^{A}Pᵢ=^{A}pᵣᵢ+^{A}Pᵣₖᵢ, wherein ^{A}Pᵣₖᵢ is a position vector pointing from the pivot of the mobile robot to the odometry coordinates of the k-th RFID reader, and is represented by the following Equation.

$${}_{}^{A}{P}{}_{r k i}^{} = [ \begin{matrix}{r}_{k} cos ( {θ}_{i} + {β}_{k} ) \\ {r}_{k} sin ( {θ}_{i} + {β}_{k} ) \\ 1\end{matrix} ] \qquad ( 4 )$$

Consequently, ^{c}Pᵢ is arranged as the following Equation.

$$\begin{matrix}{}_{}^{C}{P}{}_{i}^{} = {}_{A}^{C} T \cdot {}_{}^{A}{P}{}_{i}^{} \\ = {}_{A}^{C} T \cdot ( {}_{}^{A}{P}{}_{r i}^{} + {}_{}^{A}{P}{}_{r k i}^{} )\end{matrix} \qquad ( 5 )$$

In Equation (5), _{C}^{A}T is a conversion matrix to make ^{A}pᵢ coincide with ^{c}Pᵢ, and is given by the following Equation.

$${}_{A}^{C} T = [ \begin{matrix}cos ( α ) & - sin ( α ) & {d}_{x} \\ sin ( α ) & cos ( α ) & {d}_{y} \\ 0 & 0 & 1\end{matrix} ] \qquad ( 6 )$$

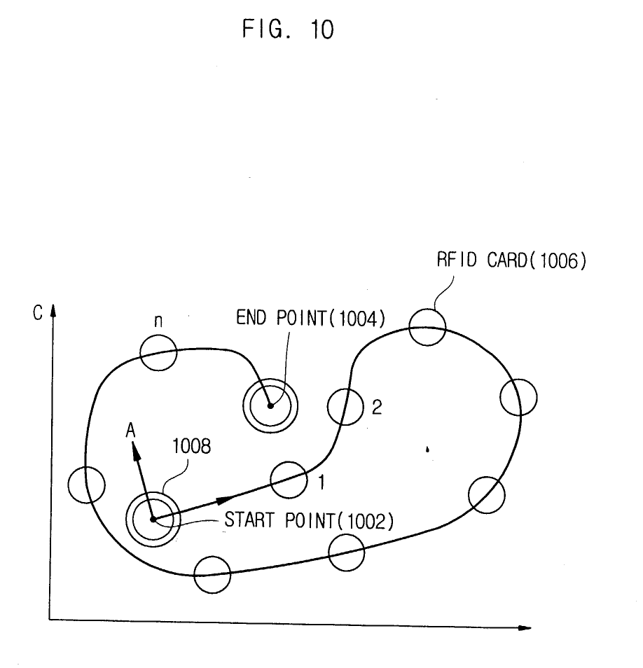

Therefore, if a test motion of FIG. 10 is performed (as described later), and values of Equation (5) are then calculated by analyzing results of the test motion, information required to make the odometry coordinate system coincide with the RFID coordinate system is obtained. For the above-described test, the mobile robot must recognize two or more RFID cards. If the mobile robot moves at a constant speed, and specifications of the RFID card and RFID reader are given, error of the RFID coordinate system may be determined. Therefore, to reduce a total error (RFID error+odometry error) of recognizing the position and direction of the mobile robot, the RFID cards must be arranged so as to make accumulated error in the odometry coordinate system smaller than the RFID reader.

FIG. 10 is a view showing a test motion to make the odometry and RFID coordinate systems of the mobile robot coincide with each other. FIG. 10 shows a case where a mobile robot 1008 of the present invention detects a total of n RFID cards 1006 while moving between a start point 1002 and an end point 1004. A path for the test motion of the mobile robot 1008 is set arbitrarily.

As shown in FIG. 10, odometry coordinates at the start point 1002 where the mobile robot 1008 starts the test motion are (^{A}xᵣₛ, ^{A}yᵣₛ, ^{A}θᵣₛ), and are generally initialized as (0, 0, 0). The mobile robot 1008 detects the total of n RFID cards 1006 while performing the test motion, and obtains both the RFID and odometry coordinates at each of the detection points of the RFID cards. Further, odometry coordinates at the end point 1004 of the mobile robot 1008 are (^{A}xᵣₑ, ^{A}yᵣₑ, ^{A}θᵣₑ), and their revised odometry coordinates are (^{C}xᵣₑ, ^{C}yᵣₑ, ^{C}θᵣₑ). The above operations are summarized as shown in Table 1 below.

TABLE 1

| | | | Revised odometry |
|---|---|---|---|
| RFID # | RFID coordinates | Odometry coordinates | coordinates |
| Start point | — | ^{A}xᵣₛ, ^{A}Yᵣₛ, ^{A}θᵣₛ | — |
| 1 | ^{C}x₁, ^{C}y₁ | ^{A}xᵣ₁, ^{A}yᵣ₁, ^{A}θᵣ₁ | — |
| 2 | ^{C}x₂, ^{C}y₂ | ^{A}xᵣ₂, ^{A}yᵣ₂, ^{A}θᵣ₂ | — |
| . . . | . . . | . . . | — |
| N | ^{C}xₙ, ^{C}yₙ | ^{A}xᵣₙ, ^{A}yᵣₙ, ^{A}θᵣₙ | — |
| End point | — | ^{A}xᵣₑ, ^{A}yᵣₑ, ^{A}θᵣₑ | ^{C}Xᵣₑ, ^{C}Yᵣₑ, ^{C}θᵣₑ |

If data are obtained through the above test motion of the mobile robot, unknown values of dₓ, d_{y} and α may be obtained by the following algorithms.

$$\begin{matrix}{}_{}^{C}{x}{}_{i}^{} = cos ( α ) ( {}_{}^{A}{x}{}_{r i}^{} + {r}_{k} cos ( {}_{}^{A}{θ}{}_{r i}^{} + {β}_{k} ) ) - sin ( α ) ( {}_{}^{A}{y}{}_{r i}^{} + {r}_{k} sin ( {}_{}^{A}{θ}{}_{r i}^{} + {β}_{k} ) ) + {d}_{x} ( i = 1 , 2 , … , n ) & ( 7 ) \\ {}_{}^{C}{y}{}_{i}^{} = sin ( α ) ( {}_{}^{A}{x}{}_{r i}^{} + {r}_{k} cos ( {}_{}^{A}{θ}{}_{r i}^{} + {β}_{k} ) ) + cos ( α ) ( {}_{}^{A}{y}{}_{r i}^{} + {r}_{k} sin ( {}_{}^{A}{θ}{}_{r i}^{} + {β}_{k} ) ) + {d}_{y} ( i = 1 , 2 , … , n ) & ( 8 )\end{matrix}$$

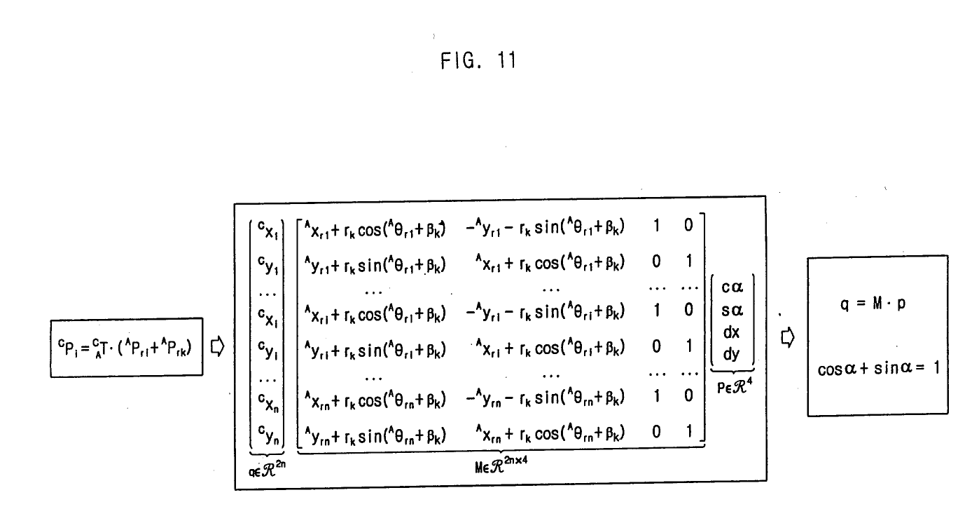

If required parameters are extracted from Equations (7) and (8), and the extracted parameters are represented by matrixes, the result of FIG. 11 is obtained. Further, if the matrixes of FIG. 11 are represented by q, M and p, respectively, the following relation may be obtained.

q=M·p (9)

In Equation (9) of FIG. 11, a vector matrix p is an unknown quantity to be obtained to make the odometry and RFID coordinate systems coincide, and q and M are values which are found through measurement. Of elements of the vector matrix p which are of an unknown quantity, unknown quantities related to the angle α are increased to cα and sα, since cosα and sinα are nonlinear equations and it is difficult to obtain only α. Therefore, the unknown quantities are represented by other unknown quantities such as cα and sα.

A least square method is a method of obtaining a function for most clearly representing measured experimental data from obtained data. The following parameter vector p is calculated from Equation (9) indicated in FIG. 11 by using the least square method.

p=(M^{T}WM)⁻¹M^{T}Wq (10)

In Equation (10), W is a weighting vector, and is calculated by the following Equation.

$$W = [ \begin{matrix}{w}_{1} & 0 & 0 & 0 & 0 & 0 \\ 0 & {w}_{1} & 0 & 0 & 0 & 0 \\ 0 & 0 & {w}_{i} & 0 & 0 & 0 \\ 0 & 0 & 0 & {w}_{i} & 0 & 0 \\ 0 & 0 & 0 & 0 & {w}_{n} & 0 \\ 0 & 0 & 0 & 0 & 0 & {w}_{n}\end{matrix} ] ∈ {R}^{( 2 n \times 2 n )} \qquad ( 11 )$$

Further, the angle α between the two coordinate systems is obtained as follows.

α=tan⁻¹ 2(sα, cα) (12)

By using the obtained dₓ, d_{y} and α, the absolute position and direction of the mobile robot is obtained by the following Equation.

$$[ \begin{matrix}{}_{}^{C}{x}{}_{re}^{} \\ {}_{}^{C}{y}{}_{re}^{} \\ {}_{}^{C}{θ}{}_{re}^{}\end{matrix} ] = [ \begin{matrix}{}_{A}^{C} T \cdot {}_{}^{A}{x}{}_{re}^{} \\ {}_{A}^{C} T \cdot {}_{}^{A}{y}{}_{re}^{} \\ {}_{}^{A}{θ}{}_{re}^{} + α\end{matrix} ] \qquad ( 13 )$$

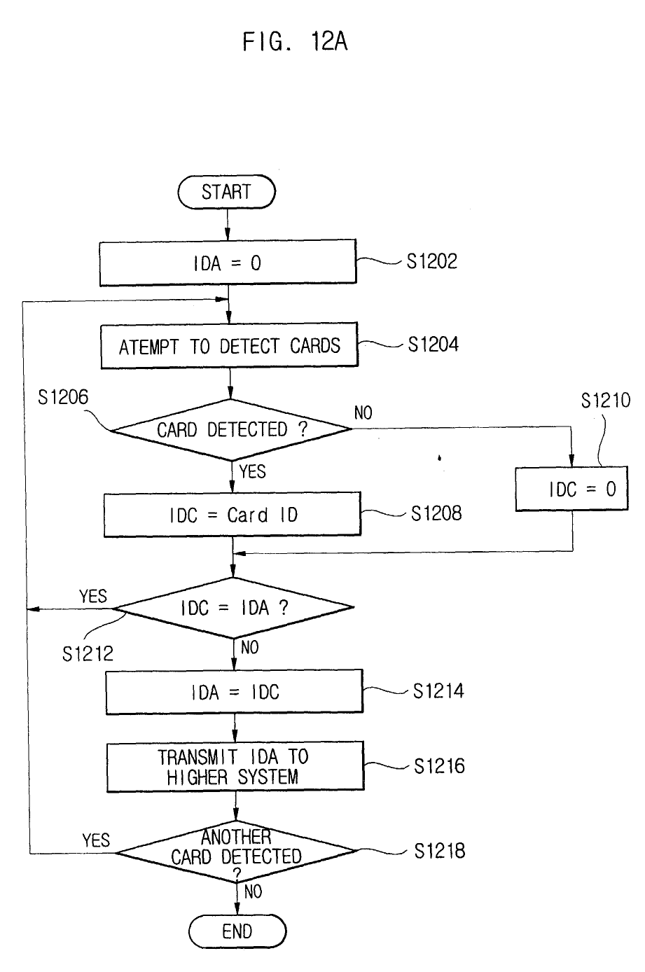

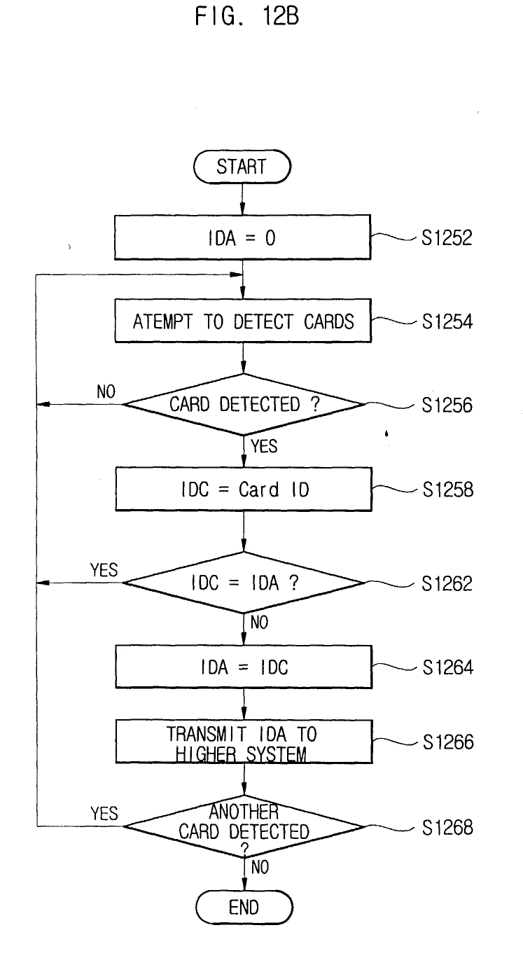

FIG. 12A is a flowchart of an algorithm performed by the RFID reader modules if an RFID card is not detected. As indicated in Table 2 below, if each of the RFID reader modules detects an RFID card, it stores a corresponding unique number. If the RFID card is not detected, the RFID reader module stores “0”. However, only if a unique number of a new RFID card, not a previously detected unique number (including “0”), is detected, the RFID reader module transmits data to a higher system, thus reducing the amount of communication and load on a control unit.

TABLE 2

| Detection sequence | 1 | 2 | 3 | 4 | 5 | 6 | 7 | 8 | 9 |
|---|---|---|---|---|---|---|---|---|---|
| Detection result | o | x | o | x | x | o | O | x | o |
| Detected unique number | 37 | — | 39 | — | — | 54 | 56 | — | 63 |
| Unique number transmitted | 37 | 0 | 39 | 0 | — | 54 | 56 | 0 | 63 |
| to higher system | | | | | | | | | |

As shown in FIG. 12A, a previous unique number IDA, which is previously detected and stored in the control unit of the mobile robot, is initialized to “0” at operation S1202. If an RFID card is detected by attempting to detect RFID cards at operations S1204 to S1206, a unique number CardID of the newly detected RFID card is assigned to a current unique number IDC at operation S1208. If a new RFID card is not detected by attempting to detect RFID cards at operation S1204 to S1206, “0” is assigned to the current unique number IDC, thus indicating that a new RFID card is not detected at operation S1210.

If the value of the current unique number IDC is updated, it is determined whether the values of IDC and IDA are identical at operation S1212. If the values of IDC and IDA are identical, that is, if a new RFID card is not detected, the process returns to the operation S1204 to attempt to detect RFID cards. On the other hand, if the values of IDC and IDA are not identical, that is, if a new RFID card is detected and a new unique number, not “0”, is assigned to IDC, the current unique number IDC of the newly detected RFID card is assigned to the previous unique number IDA at operation S1214. Thereafter, the RFID reader module transmits the IDA with the new value assigned thereto to the higher system at operation S1216. After the transmission of the new IDA is completed, detection for another RFID card is attempted or the process ends at operation S1218.

FIG. 12B is a flowchart of an algorithm performed by the RFID reader modules to reduce an amount of communication. As indicated in Table 3 below, each of the RFID reader modules neither stores therein a condition of IDC=0 representing that a new RFID card is not detected, nor transmits the condition to the higher system.

TABLE 3

| Detection sequence | 1 | 2 | 3 | 4 | 5 | 6 | 7 | 8 | 9 |
|---|---|---|---|---|---|---|---|---|---|
| Detection result | O | x | o | x | x | O | o | x | o |
| Detected unique number | 37 | — | 39 | — | — | 54 | 56 | — | 63 |
| Unique number transmitted | 37 | — | 39 | — | — | 54 | 56 | — | 63 |
| to higher system | | | | | | | | | |

As shown in FIG. 12B, a previous unique number IDA, which is previously detected and stored in the control unit of the mobile robot, is initialized to “0” at operation S1252. If an RFID card is detected by attempting to detect RFID cards at operations S1254 to S1256, a unique number CardID of the newly detected RFID card is assigned to a current unique number IDC at operation S1258. If a new RFID card is not detected by attempting to detect RFID cards at operation S1254 to S1256, the operation S1254 to attempt to detect RFID cards is repeated.

If the new RFID card is detected and the value of the current unique number IDC is updated, it is determined whether the values of IDC and IDA are identical at operation S1262. If the values of IDC and IDA are identical, that is, if a new RFID card is not detected, the process returns to the operation S1254 to attempt to detect RFID cards. On the other hand, if the values of IDC and IDA are not identical, that is, if a new RFID card is detected and a new unique number is assigned to IDC, the current unique number IDC of the newly detected RFID card is assigned to the previous unique number IDA at operation S1264. Thereafter, the RFID reader module transmits the IDA with the new value assigned thereto to the higher system at operation S1266. After the transmission of the new IDA is completed, detection for another RFID card is attempted or the process ends at operation S1268.

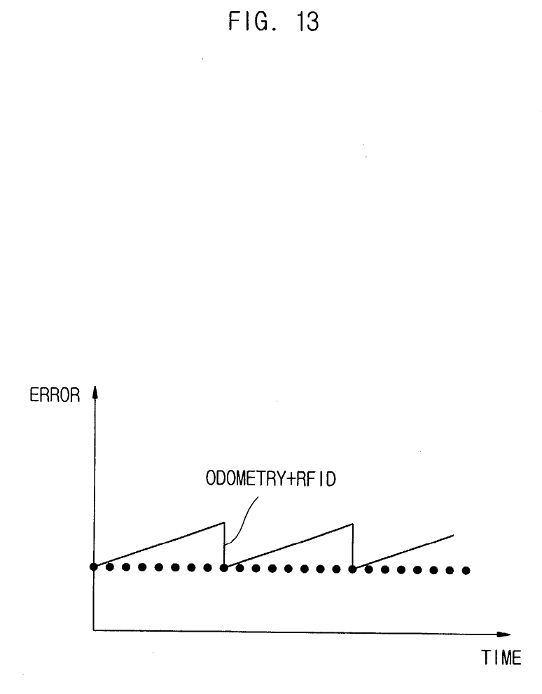

FIG. 13 is a graph showing error characteristics of the method of recognizing the position and direction of the mobile robot of the present invention. As shown in FIG. 13, by operating the odometry and RFID methods in combination with each other, the position and direction of the mobile robot are recognized by odometry for a short moving distance. Further, whenever RFID cards are detected, position and direction information is updated using absolute position information provided from the RFID cards, thus correcting error accumulated by odometry. In this way, since the present invention operates the odometry and RFID methods in combination with each other, it obtains improved effects of restricting an error range within a predetermined level by the RFID method and simultaneously obtaining a high sampling rate by the odometry method.

As described above, the present invention provides an apparatus and method of recognizing the position and direction of a mobile robot, which operates odometry and RFID coordinate systems in combination with each other, thus obtaining a high sampling rate by the odometry coordinate system while restricting an error range within a predetermined level by the RFID coordinate system. Consequently, the present invention is advantageous in that it recognizes the position and direction of the mobile robot at a high sampling rate and within a restricted error range.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A mobile robot, comprising:
an absolute coordinate detecting unit to obtain absolute coordinates at a current position of the mobile robot;
a relative coordinate detecting unit to obtain relative coordinates for a moving displacement of the mobile robot; and
a control unit to recognize a position and direction of the mobile robot by reflecting the relative coordinates on the absolute coordinates.

2. The mobile robot according to claim 1, wherein the absolute coordinate detecting unit is an RFID (Radio Frequency Identification) detecting unit to obtain a unique number from at least one RFID card laid in a work area of the mobile robot.

3. The mobile robot according to claim 2, wherein the RFID card comprises:
an inductor wound in a shape of a circle to transmit/receive RF signals; and
a storage unit to store the unique number which represents a position of the RFID card.

4. The mobile robot according to claim 1, wherein the relative coordinate detecting unit is a dead-reckoning device, comprising:
a speed sensor to detect a moving speed of the mobile robot; and
a direction sensor to detect a progressing direction of the mobile robot.

5. A method of recognizing a position and direction of a mobile robot, comprising:
obtaining absolute coordinates at a current position of the mobile robot;
obtaining relative coordinates for a moving displacement of the mobile robot; and
recognizing the position and direction of the mobile robot by reflecting the relative coordinates on the absolute coordinates.

6. The method according to claim 5, further comprising:
performing coordinate alignment of the absolute and relative coordinates.

7. The method according to claim 5, wherein the obtaining absolute coordinates comprises:
detecting at least one RFID (Radio Frequency Identification) card laid in a work area of the mobile robot;
obtaining a unique number assigned to the RFID card; and
obtaining absolute coordinates corresponding to the unique number.

8. The method according to claim 6, wherein the relative coordinates are fixed to a pivot of the mobile robot, thereby allowing the position and direction of the mobile robot to be recognized by taking in to account a distance and direction between the pivot of the mobile robot and a mounting position of the absolute coordinates.

9. A storage medium to store data to perform a process related to recognize a position and direction of a mobile robot, the process comprising:
obtaining absolute coordinates at a current position of the mobile robot;
obtaining relative coordinates for a moving displacement of the mobile robot; and
recognizing the position and direction of the mobile robot by reflecting the relative coordinates on the absolute coordinates.

10. The storage medium according to claim 9, further comprising:
performing coordinate alignment of the absolute and relative coordinates.

11. The storage medium according to claim 9, wherein the obtaining absolute coordinates comprises:
detecting at least one RFID (Radio Frequency Identification) card laid in a work area of the mobile robot and stored in a control unit of the mobile robot;
obtaining a unique number assigned to the RFID card; and
obtaining absolute coordinates corresponding to the unique number.

12. A control apparatus of a mobile robot, comprising:
an RFID (Radio Frequency Identification) reader;
an encoder;
a control unit to recognize a position and direction of the mobile robot based on information obtained by the RFID reader and encoder which are connected to an input terminal of the control unit.

13. The apparatus according to claim 12, wherein the RFID reader detects RFID cards, obtains unique numbers from the detected RFID cards which are laid on a floor of a work area of the mobile robot, and transmits the unique numbers to the control unit to obtain RFID coordinates of the mobile robot.

14. The apparatus according to claim 13, wherein the encoder detects a rotating speed and rotating direction of wheels of the mobile robot, and transmits detected values corresponding to the rotation speed and the rotation direction of the wheels to the control unit to obtain odometry coordinates of the mobile robot.

15. The apparatus according to claim 12, further comprising:
a plurality of RFID reader modules to obtain unique numbers from RFID cards; and
an RFID reader system disposed between the control unit and the RFID reader modules to allow the RFID reader modules to communicate directly with the RFID reader system, thereby reducing a load of the control unit.

16. The apparatus according to claim 13, wherein the RFID cards are coils formed in a shape of a circle so as to remove detection error in a moving direction of the mobile robot during the detection of the RFID cards, thereby obtaining identical detection points of time regardless of an approaching direction of the mobile robot to the RFID cards.

17. The apparatus according to claim 16, wherein the RFID cards comprise a circuit unit which includes a rectifying device, a basic RF modulation device, and a non-volatile memory.

18. The apparatus according to claim 16, wherein when the RFID cards are detected, position and direction information of the mobile robot is updated using absolute position information provided from the RFID cards, thereby correcting error accumulated by odometry.
